(19) United States
(12) Patent Application Publication
(10) Pub. No.: US 2015/0354406 A1
(43) Pub. Date: Dec. 10, 2015

(54) BLADE OUTER AIR SEAL AND METHOD OF MANUFACTURE

(71) Applicants: John R. FARRIS, Bolton, CT (US); Thomas N. SLAVENS, Vernon, CT (US)

(72) Inventors: John R. FARRIS, Bolton, CT (US); Thomas N. SLAVENS, Vernon, CT (US)

(73) Assignee: United Technologies Corporation, Hartford, CT (US)

(21) Appl. No.: 14/707,800

(22) Filed: May 8, 2015

Related U.S. Application Data
(60) Provisional application No. 62/008,173, filed on Jun. 5, 2014.

(51) Int. Cl. F01D 25/14; B22F 3/105; F01D 9/02; B22F 3/115; F01D 5/20; F01D 25/24

(52) U.S. Cl. CPC F01D 25/145; F01D 5/20; F01D 25/24; F01D 9/02; B22F 3/115; B22F 3/105; B22F 3/1055; F05D 2220/32; F05D 2230/31; F05D 2230/22; F05D 2230/90; F05D 2260/231

(57) ABSTRACT

The present disclosure relates to gas turbine engine components, such as blade outer air seals and methods of manufacture. In one embodiment, a gas turbine engine component includes a retention interface formed by an additive manufacturing process. The gas turbine engine component can include a retention interface having a pattern, and a thermal barrier layer formed to the retention interface.

### CROSS-REFERENCE TO RELATED APPLICATIONS

This application claims priority to U.S. Provisional Application No. 62/008,173 filed on Jun. 5, 2014 and titled BLADE OUTER AIR SEAL AND METHOD OF MANUFACTURE, the disclosure of which is hereby incorporated by reference in its entirety.

### FIELD

The present disclosure relates to components for a gas turbine engine and, more particularly, relates to gas turbine engine components having a retention interface formed by an additive manufacturing process.

### BACKGROUND

Gas turbine engines, particularly those used in aircraft, operate at high rotational speeds and high temperatures for increased performance and efficiency. The turbine of a modern gas turbine engine is typically of an axial flow design and includes a plurality of axial flow stages. Each axial flow stage can include a plurality of blades mounted radially at the periphery of a disk which is secured to a shaft. A plurality of duct segments surround the stages to limit the leakage of gas flow around the tips of the blades. These duct segments are located on the inner surface of a static housing or casing. The incorporation of the duct segments improves thermal efficiency because more work may be extracted from gas flowing through the stages as opposed to leaking around the blade tips.

Although the duct segments limit gas flow leakage around blade tips, these segments do not completely eliminate gas flow leakage. Minor amounts of gas flow around the blade tips detrimentally affect turbine efficiency. Thus, gas turbine engine designers proceed to great lengths to devise effective sealing structures to provide a radial surface along the flow path of the engine and seal the structure and increase turbine efficiency. However, any structure within the gas turbine engine may develop hot spots.

Current processes for manufacturing a blade outer air seal retention interface can be improved in effectiveness, and cost. Known processes may apply a thick metallic interface and may drill a large number of small holes into the interface. These holes are drilled into the interface in a uniform shape and depth.

Accordingly, there exists a need for a blade outer air seal and manufacturing process which is more cost effective and maintains turbine efficiency. In addition, there exists a need to manufacture a blade outer air seal retention interface where the pattern can be varied to aid in reducing heat and wear of a blade outer air seal and aid in maintaining turbine engine efficiency.

### BRIEF SUMMARY OF THE EMBODIMENTS

Disclosed and claimed herein are gas turbine engine components and methods for manufacturing. One embodiment is directed to gas turbine engine component including a substrate, and a retention interface formed on a surface of the substrate, wherein the retention interface is formed by an additive manufacturing process to include a pattern. The gas turbine engine component also includes a thermal barrier layer formed to the retention interface.

In one embodiment, the gas turbine engine component is at least one of a blade outer air seal, vane, turbine frame, and casing.

In one embodiment, the substrate is one or more structural layers or elements of the gas turbine engine component.

In one embodiment, the retention interface is formed by at least one of direct metal laser sintering, laser spray metal deposition, laser processing and metal deposition.

In one embodiment, the retention interface has a thickness within the range of 1 to 50 μm.

In one embodiment, the retention interface is applied to the entirety of the substrate.

In one embodiment, the retention interface is applied to one or more discrete sections of the substrate.

In one embodiment, the pattern includes a base layer and a plurality of divots formed on the base layer.

In one embodiment, a ligament thickness of each divot is one of a uniform thickness and a tapered thickness.

In one embodiment, the gas turbine engine component includes a transition between regions where the retention interface is applied and the substrate, wherein the transition is at least one of a planar, and non-planar transition.

Another embodiment is directed to a method of manufacturing a gas turbine engine component. The method including forming a retention interface to a substrate, wherein the retention interface is formed by an additive manufacturing process to include a pattern and forming a thermal barrier layer on the retention interface.

In one embodiment, the substrate is one or more structural layers or elements of at least one of a blade outer air seal, vane, turbine frame, and casing.

In one embodiment, the method includes forming the retention interface to a substrate by at least one of direct metal laser sintering, laser spray metal deposition, laser processing and metal deposition.

In one embodiment, the method includes forming the retention interface to a substrate with a thickness within the range of 1 to 50 μm.

In one embodiment, the method includes forming the retention interface to a substrate is applied to the entirety of the substrate.

In one embodiment, the method includes forming the retention interface to a substrate is applied to one or more discrete sections of the substrate.

In one embodiment, the method includes forming the retention interface to a substrate is built by a computer controlled at least one of direct metal laser sintering, laser spray metal deposition, laser processing and metal deposition general.

In one embodiment, the method includes forming the retention interface to a substrate by building in at least one direction a single layer at a time and each additional layer is built onto the previous constructed layer.

In one embodiment, the method includes forming the retention interface to a substrate includes forming a ligament thickness for each divot having one of a uniform thickness and a tapered thickness.

In one embodiment, the method includes forming a transition between regions where the retention interface is applied and the substrate, wherein the transition is at least one of a planar and non-planar transition.

Other aspects, features, and techniques will be apparent to one skilled in the relevant art in view of the following detailed description of the embodiments.

### BRIEF DESCRIPTION OF THE DRAWINGS

The features, objects, and advantages of the present disclosure will become more apparent from the detailed description set forth below when taken in conjunction with the drawings in which like reference characters identify correspondingly throughout and wherein:

FIG. 1 depicts a graphical representation of a blade outer air seal according to one or more embodiments;

FIGS. 2A-2C depict graphical representations of a retention interface according to one or more embodiments;

FIGS. 3A-3B depict graphical representations of a retention interface according to one or more embodiments;

FIG. 4 depicts a process for manufacturing a blade outer air seal according to one or more embodiments; and

FIGS. 5A-5B depict graphical representations of blade outer air seal according to one or more other embodiments.

### DETAILED DESCRIPTION OF THE EXEMPLARY EMBODIMENTS

### Overview and Terminology

One aspect of this disclosure relates to components, such as components for a gas turbine engine. In one embodiment, a retention interface is provided for components, such as one or more of blade outer air seals, vanes, turbine frames, casing, etc. In one embodiment, a blade outer air seal is a shroud portion or a section of a gas turbine engine between blades and an outer engine case. In one embodiment, a blade outer air seal may be formed by a plurality of body segments. As used herein, blade outer air seal may refer to an entire shroud, and/or segments of a shroud. According to another embodiment, a retention interface is provided for a blade outer air seal to allow for retention of a thermal barrier layer to surfaces of the blade outer air seal.

Another aspect of the disclosure relates to manufacturing gas turbine engine components, such as a blade outer air seal. In one embodiment, methods are provided for applying coatings to a blade outer air seal, such as a thermal barrier layer. In another embodiment, a method for forming a blade outer air seal includes forming a retention interface on a surface of a blade outer air seal. According to another embodiment, a retention interface may be formed by an additive manufacturing process. The retention interface may be formed to include a divot pattern.

As used herein, the terms “a” or “an” shall mean one or more than one. The term “plurality” shall mean two or more than two. The term “another” is defined as a second or more. The terms “including” and/or “having” are open ended (e.g., comprising). The term “or” as used herein is to be interpreted as inclusive or meaning any one or any combination. Therefore, “A, B or C” means “any of the following: A; B; C; A and B; A and C; B and C; A, B and C”. An exception to this definition will occur only when a combination of elements, functions, steps or acts are in some way inherently mutually exclusive.

Reference throughout this document to “one embodiment,” “certain embodiments,” “an embodiment,” or similar term means that a particular feature, structure, or characteristic described in connection with the embodiment is included in at least one embodiment. Thus, the appearances of such phrases in various places throughout this specification are not necessarily all referring to the same embodiment. Furthermore, the particular features, structures, or characteristics may be combined in any suitable manner on one or more embodiments without limitation.

### Exemplary Embodiments

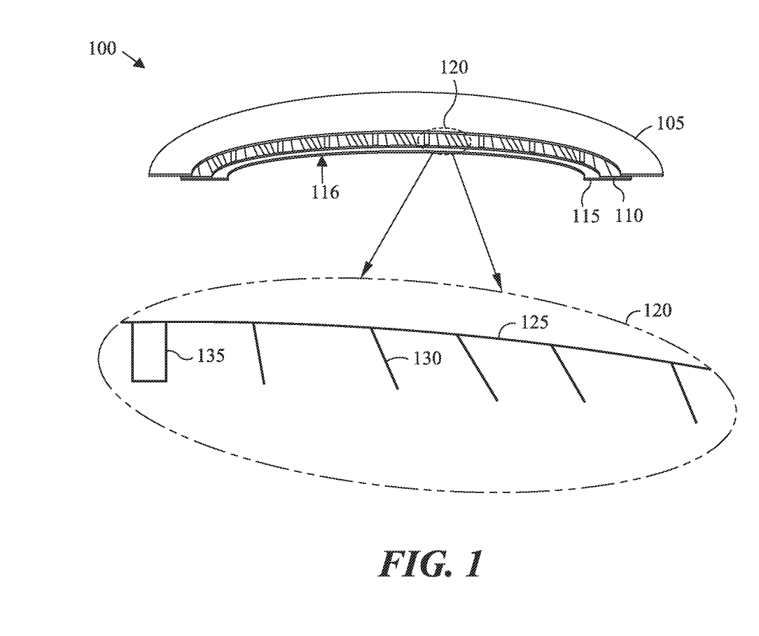

Referring now to the figures, FIG. 1 depicts a graphical representation of a gas turbine engine component, and in particular, a blade outer air seal according to one or more embodiments. In one embodiment, blade outer air seal 100 represents a portion of an engine shroud. In another embodiment, blade outer air seal 100 represents a portion or a section of a gas turbine engine between blades (e.g., fan, turbine, etc.) and an outer engine case. Blade outer air seal 100 can represent one of a plurality of body segments that form an engine shroud. Blade outer air seal 100 may relate to a segment of a segmented blade outer air seal that included a plurality of segments extending around the circumference of engine blades configured to limit air leakage between blades and the engine case. Blade outer air seal 100 may be employed for gas turbine engines, generators, etc.

In FIG. 1, a side representation is depicted of blade outer air seal 100. As shown, blade outer air seal 100 may be one or a plurality of segments. It should also be appreciated that blade outer air seal 100 can relate to a particular stage or stages of a gas turbine engine. By way of example, blade outer air seal 100 may be part of a turbine or hot section of a gas turbine engine. According to one embodiment, blade outer air seal 100 includes substrate 105, retention interface 110, and thermal barrier layer 115.

Substrate 105 is one or more structural layers or elements of a gas turbine engine component. Substrate 105 may be a structural element of a gas turbine engine, such as a shroud that is a metal or metal alloy structure. In one embodiment, retention interface 110 is applied to substrate 105. Retention interface 110 may be applied to portions of substrate 105 which receive a thermal barrier layer 115. By way of example, retention interface 110 may be applied and/or formed to an inner radial surface, shown as 116, of substrate 105. Inner radial surface 116 of blade outer air seal 100 may be a circumferential surface of blade element 100 that faces blades of a turbine engine.

In one embodiment, retention interface 110 and thermal layer 115 may relate to a protective coating applied to a gas turbine engine component, such as a blade outer air seal. In certain embodiments, portions of inner radial surface 116 of substrate 105 may not include retention interface 110 and thermal layer 115. By way of example, retention interface 110 and thermal layer 115 may be applied to areas of a blade outer air seal 100 that experience high thermal stress. In some embodiments, portions of substrate 105 may not be covered by retention interface 110. For example, retention interface 110 may be formed or applied to one or more portions of substrate 105.

According to one or more embodiments, retention interface 110 may be applied to a substrate without requiring drilling or removal of bonding material to form divots. According to a further embodiment, application of retention interface 110 may allow for the formation of a geometric pattern or divot pattern that allows for improved adhesion of a thermal layer (e.g., thermal layer 115).

According to one embodiment, retention interface 110 may be applied to substrate 105 by an additive manufacturing technique. As such, retention interface 110 may be formed to include a pattern of one or more divots (e.g., raised features) that allow for better adhesion of thermal layer 115. According to another embodiment, retention interface 110 may include one or more of a base layer 125 and raised portions shown as 130 and 135. Divots 130 and 135 may relate to raised portions, nodules, stacks or columns of material. An enlarged representation of retention interface 110 is shown as 120 in FIG. 1 for the purpose of illustration. Base layer 125 may be applied to substrate 105. Divots 130 and 135 may be additively manufactured to base layer 125. In certain embodiments, base layer 125 may be optional. According to another embodiment, the dimensions, placement, orientation and configuration of a pattern or divots included in retention interface 110 may allow for improved bonding and resilience of thermal layer 115. As shown in FIG. 1, divots 130 extend outwardly and diagonally from base layer 125 and may be raised stacks of columns of material. According to one embodiment, by manufacturing divots 130 and 135 through an additive manufacturing process, retention interface does not requiring drilling, or other material removal, to provide divots or an abradable pattern in retention interface 110. Divot 135 relates to a divot having a particular width and depth.

Thermal layer 115 may be a barrier layer to provide increased heat tolerance for sections of the blade outer air seal 100 and may be formed of Yttria-Stabilized Zirconia, or other elements. Substrate 105 may be formed of a cobalt or nickel alloy.

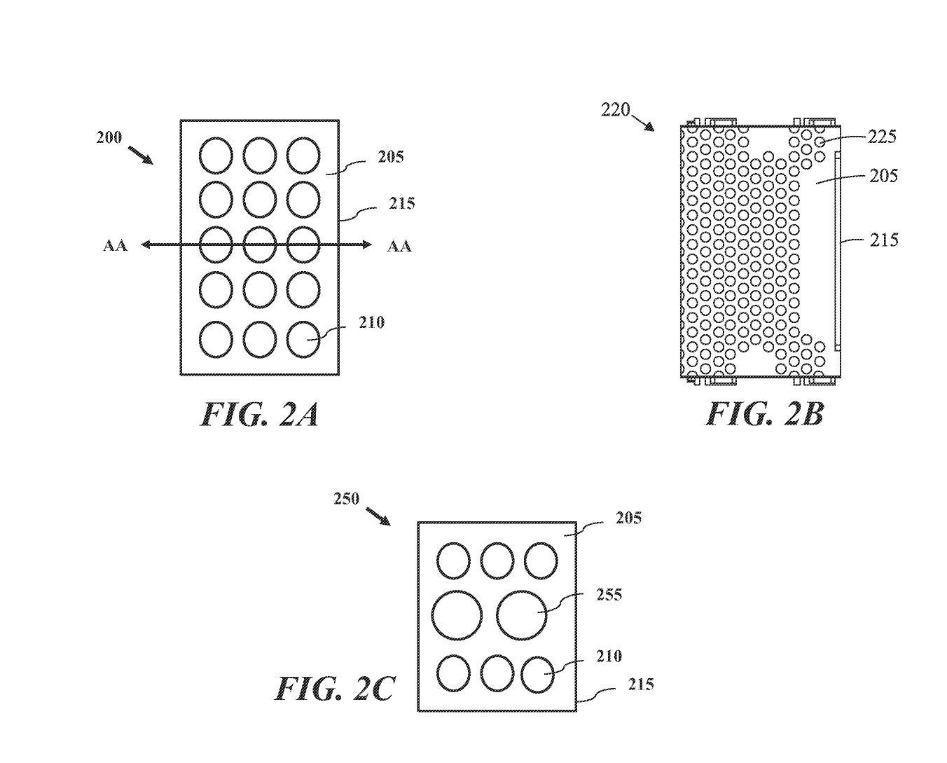

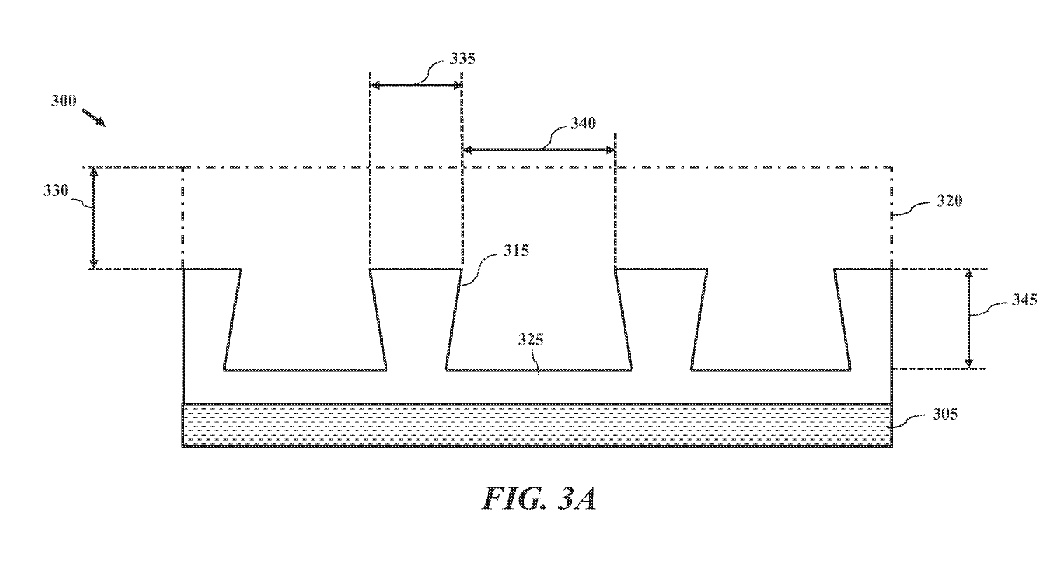

FIGS. 2A-2C depict top-down graphical representations of a retention interface, such as retention interface may be formed by an additive manufacturing process to include a divot pattern, according to one or more embodiments. In FIG. 2A, a top-down view is shown of a patter, or divot pattern, according to one or more embodiments. Divot pattern 200 includes base retention interface layer 205 and a plurality of divots, such as divot 210. According to one embodiment, a divot pattern may be the position, orientation, size and distribution of divots (e.g., retention interface material) that extend from a base retention interface layer. According to one embodiment, divots, such as divot 210, may be formed with equal size and equal spacing. Base retention interface layer 205 may be applied to at least a portion of an inner radial surface of a blade outer air seal (e.g., blade outer air seal 100). Divot pattern 200 may be formed as a retention interface by an additive manufacturing process to include a divot pattern wherein the divots, such as divot 210, uniformly applied to the entirety of the base retention interface layer 205. A cross-sectional view of divots in FIG. 2A are shown in FIGS. 3A and 3B.

In FIG. 2B, divot pattern 220 includes base retention interface layer 205 and a plurality of divots, such as divot 225. According to one embodiment, divot pattern 220 is distributed only along a portion of base retention interface layer 205 (e.g., not formed along the entire base retention interface layer 205). The retention interface of FIG. 2B is formed by an additive manufacturing process to include divot pattern 220 applied to sections of a blade outer air seal. Divot pattern 220 may be constructed uniformly or non-uniformly to discrete sections of the substrate.

In FIG. 2C, divot pattern 250 includes base retention interface layer 205 and a plurality of divots, such as divot 210 and divot 255, wherein divot 255 is larger than divot 210. The retention interface of FIG. 2C is formed by an additive manufacturing process to include divot pattern 250 applied to a blade outer air seal. Divot pattern 250 may be formed to include a non-uniform divot pattern wherein each divot may vary in size, shape, and depth etc.

According to one or more embodiments, a retention interface may be applied to a substrate of a blade outer air seal (e.g., blade outer air seal 100) and/or other components to include one or more abradable features that does not require drilling or removal of retention interface material. According to a further embodiment, application and/or formation of a retention interface (e.g., retention interface 110) may allow for the formation of divots extending above a base retention layer.

FIGS. 3A-3B depict graphical representations of a retention interface according to one or more embodiments. In FIG. 3A, a cross section of retention interface 200 of FIG. 2A is depicted along the line AA according to one embodiment. Retention interface 300 is formed to substrate 305 (e.g., substrate 105) and includes a pattern having a plurality of divots (e.g., divot 210). The retention interface 300 is formed by an additive manufacturing process to include divots, such as divot 315 (e.g., divot 210). Thermal layer 320 is shown in FIG. 3A for illustration. According to one embodiment, thermal layer 320 may be built above divot 315 to a height 330 which may be with in the range of 1 to 0.50 cm.

Retention interface 300 includes a tapered divot pattern formed on base layer 325. Divot 315 may have a width 335 and a height 345 above base layer 325. Divot 315 may be formed with a ligament thickness 335 which may be tapered at the base of divot 335. Retention interface thickness, divot depth 345, divot spacing 340, and ligament thickness 335 may be altered to aid in reducing heat and wear of a blade outer air seal. In certain embodiments, the transition between regions where the retention interface 300 is applied and the substrate 305 may be at least one of a planar and non-planar transition. Thermal layer 320 may be formed to retention interface 300 and may have a uniform or varying layer thickness 330.

FIG. 3B depicts a cross section of retention interface 200 of FIG. 2A along the line AA according to another embodiment. Retention interface 350 is formed to substrate 305 (e.g., substrate 105) and includes plurality of divots (e.g., divot 210). The retention interface 350 is formed by an additive manufacturing process to include divots, such as divot 360 (e.g., divot 210). Thermal layer 365 is shown in FIG. 3B for illustration. According to one embodiment, thermal layer 365 may be built above divot 360 by a height of 375 which may be with in the range of 1 to 0.5 cm.

Retention interface 350 includes a uniform thickness divot pattern formed on base layer 370. Divot 360 may have a width 380 and a height 345 above base layer 370. Divot 360 may be formed with a ligament thickness 380 which may be of a uniform thickness. Retention interface thickness, divot depth 345, divot spacing 385, and ligament thickness 380 may be altered to aid in reducing heat and wear of a blade outer air seal. In certain embodiments, the transition between regions where the retention interface 300 is applied and the substrate 305 may be at least one of a planar and non-planar transition. Thermal layer 365 may be formed to retention interface 350 and may have a uniform or varying layer thickness 375.

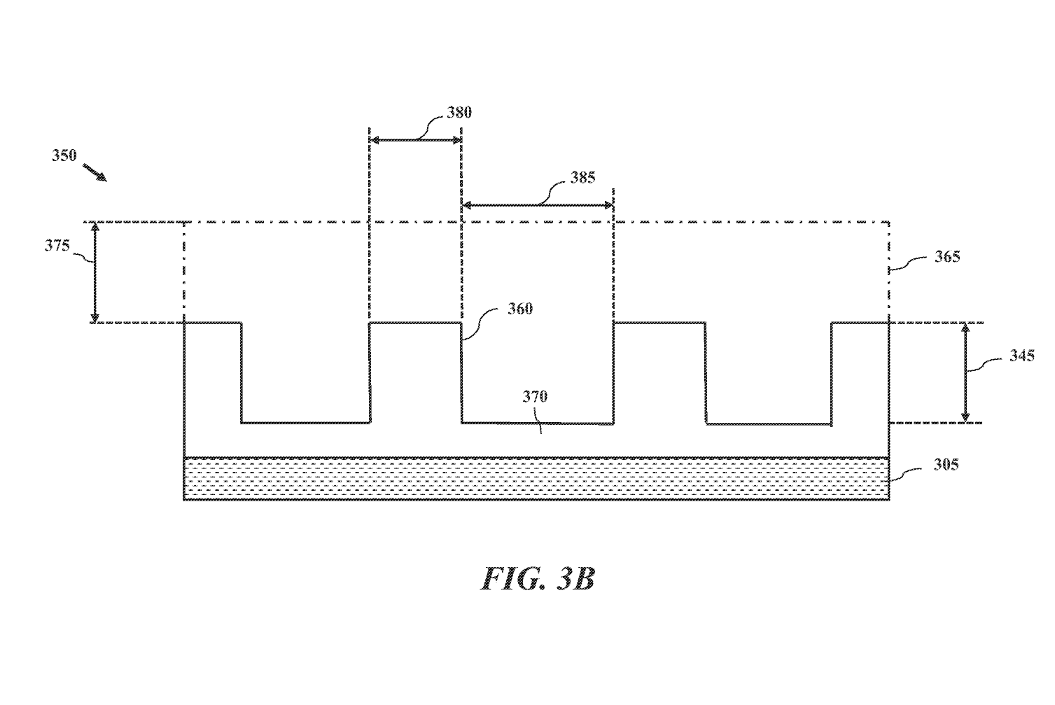

FIG. 4 depicts a process for manufacturing a gas turbine engine component, such as a blade outer air seal, according to one or more embodiments. Process 400 may be employed during manufacture of a blade outer air seal segment (e.g., blade outer air seal 100). In certain embodiments, blade out air seals may be may be manufactured as segments to simplify manufacture and coating of parts. Process 400 may be initiated by forming a retention interface at block 405. In one embodiment, the retention interface (e.g., retention interface 110) is formed by an additive manufacturing process to include a divot pattern at block 405. The divot pattern may be formed on a surface of a substrate at block 405 by at least one of direct metal laser sintering, laser spray metal deposition, laser processing and metal deposition general. In one embodiment, the retention interface is formed to a substrate with a thickness within the range of 1 to 50 μm. According to another embodiment, forming the retention interface to a substrate at block 405 includes formation of the retention interface to the entirety of the substrate. Alternatively, the retention interface to a substrate may be applied to discrete sections of the substrate.

According to another embodiment, forming the retention interface to a substrate at block 405 includes building divots by computer to control at least one of direct metal laser sintering, laser spray metal deposition, laser processing and metal deposition general. The retention interface may be formed to a substrate by building a single layer at a time in at least one direction and each additional layer is built onto the previous constructed layer. Formation at block 405 may include forming a ligament thickness of each divot to one of a uniform thickness and a tapered thickness. In certain embodiments, a substrate of a blade outer air seal may include a transition between regions where the retention interface is applied and the substrate. The transition may be at least one of a planar, and non-planar transition.

At block 410, a thermal barrier may be formed on the retention interface. The thermal barrier may be formed of Yttria-Stabilized Zirconia, or other elements.

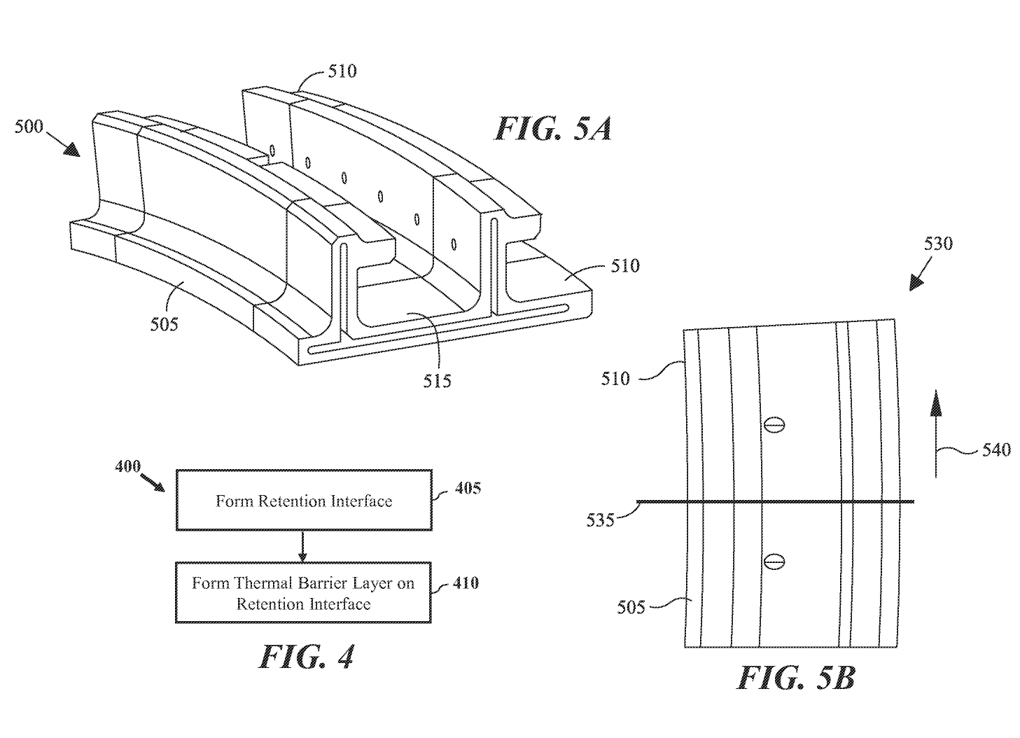

FIGS. 5A-5B depict graphical representations of blade outer air seal according to one or more other embodiments.

FIG. 5A depicts a blade outer air seal duct segment wherein a retention interface is formed on one or more discrete sections of the substrate according to one or more embodiments. Blade outer air seal 500 includes substrate 505 and duct segments 510 including a retention interface and thermal barrier layer. In that fashion, a retention interface may be applied to one or more discrete sections of blade outer air seal 500. Retention regions 510 may be juxtaposed to non-retention regions 505. In certain embodiments, the transition between retention regions 510 and non-retention regions 505 may be at least one of a planar and non-planar transition. FIG. 5A depicts blade outer air seal 500 as shrouded.

FIG. 5B depicts a graphical representation of a transition between retention interface region 510 and substrate 505. According to one embodiment, transition 535 may be one of planar and non-planar, wherein the retention interface and thermal barrier is applied in build direction 540.

While this disclosure has been particularly shown and described with references to exemplary embodiments thereof, it will be understood by those skilled in the art that various changes in form and details may be made therein without departing from the scope of the claimed embodiments.

What is claimed is:

1. A gas turbine engine component comprising:
a substrate;
a retention interface formed on a surface of the substrate, wherein the retention interface is formed by an additive manufacturing process to include a pattern; and
a thermal barrier layer formed to the retention interface.

2. The gas turbine engine component of claim 1, wherein the gas turbine engine component is at least one of a blade outer air seal, vane, turbine frame, and casing.

3. The gas turbine engine component of claim 1, wherein the substrate is one or more structural layers or elements of the gas turbine engine component.

4. The gas turbine engine component of claim 1, wherein the retention interface is formed by at least one of direct metal laser sintering, laser spray metal deposition, laser processing and metal deposition.

5. The gas turbine engine component of claim 1, wherein the retention interface has a thickness within the range of 1 to 50 μm.

6. The gas turbine engine component of claim 1, wherein the retention interface is applied to the entirety of the substrate.

7. The gas turbine engine component of claim 1, wherein the retention interface is applied to one or more discrete sections of the substrate.

8. The gas turbine engine component of claim 1, wherein the pattern includes a base layer and a plurality of divots formed on the base layer.

9. The gas turbine engine component of claim 8, wherein a ligament thickness of each divot is one of a uniform thickness and a tapered thickness.

10. The gas turbine engine component of claim 1, further comprising a transition between regions where the retention interface is applied and the substrate, wherein the transition is at least one of a planar, and non-planar transition.

11. A method of manufacturing a turbine engine component comprising:
forming a retention interface to a substrate, wherein the retention interface is formed by an additive manufacturing process to include a pattern; and
forming a thermal barrier layer on the retention interface.

12. The method of claim 11, wherein the substrate is one or more structural layers or elements of at least one of a blade outer air seal, vane, turbine frame, and casing.

13. The method of claim 11, wherein forming the retention interface to a substrate by at least one of direct metal laser sintering, laser spray metal deposition, laser processing and metal deposition.

14. The method of claim 11, wherein forming the retention interface to a substrate with a thickness within the range of 1 to 50 μm.

15. The method of claim 11, wherein forming the retention interface to a substrate is applied to the entirety of the substrate.

16. The method of claim 11, wherein forming the retention interface to a substrate is applied to one or more discrete sections of the substrate.

17. The method of claim 11, wherein forming the retention interface to a substrate is built by a computer controlled at least one of direct metal laser sintering, laser spray metal deposition, laser processing and metal deposition general.

18. The method of claim 11, wherein forming the retention interface to a substrate by building in at least one direction a single layer at a time and each additional layer is built onto the previous constructed layer.

19. The method of claim 11, wherein forming the retention interface to a substrate includes forming a ligament thickness for each divot having one of a uniform thickness and a tapered thickness.

20. The method of claim 11, further comprising forming a transition between regions where the retention interface is applied and the substrate, wherein the transition is at least one of a planar, and non-planar transition.
